(19) United States
(12) Patent Application Publication
(10) Pub. No.: US 2002/0169874 A1
(43) Pub. Date: Nov. 14, 2002

(54) Tailorable access privileges for services based on session access characteristics

(76) Inventors: Elizabeth A. Batson, Saratoga, CA (US); Anju A. Srivats, Sunnyvale, CA (US); Gopikrishna T. Kumar, Fremont, CA (US); Milind Paltanwale, San Jose, CA (US)

Correspondence Address: HEWLETT-PACKARD COMPANY, Intellectual Property Administration, P.O. Box 272400, Fort Collins, CO, 80527-2400, US

(21) Appl. No.: 09/852,259

(22) Filed: May 9, 2001

(51) Int. Cl. G06F 15/173; G06F 15/16

(52) U.S. Cl. 709/225; 709/228

(57) ABSTRACT

Method and apparatus that provide tailorable access privileges for services based on session access characteristics. In a session between a user and a software application that provides one or more services, there are various access characteristics that describe the security of the session, for example, user authentication and encryption. Various combinations of access characteristics are defined and security levels are associated with the combinations. Each of the available services also has an associated security level. Access characteristics of a session are established after a user logs in to establish a session and the user is authenticated. When a service request is received, the session's access characteristics are used to determine the session's security level. If the session's security level satisfies the security level required by the requested service, access to the service is granted. Otherwise, access is denied. Since the access characteristics are determined when a session is established, and the security levels are tailorable, services can be provided via different channels and devices without compromising security.

### FIELD OF THE INVENTION

The present invention generally relates to providing computer services, and more particularly to managing access privileges and providing access to computer services based on the access privileges.

### BACKGROUND

The growth of the Internet has contributed to the growing reliance on e-commerce by retail and business-to-business concerns. E-commerce is reshaping both business-to-business and retail transactions. The convenience and efficiency of any particular e-commerce site will play a major role in success or failure of the site.

Access to most present e-commerce sites is made by way of a personal computer (PC) or workstation running web browser software. While the PC-browser combination has certainly served as a useful starting point in the early stages of the adoption of e-commerce, the stationary nature of the PC limits the types of transactions that are suitable for e-commerce. Thus, many vendors are seeking to adapt their e-commerce sites to allow interaction with mobile devices such as wireless telephones and personal digital assistants (PDAs). If more channels are available for access to a vendor's site, it is hoped that more customers will follow.

The level of security required for e-commerce depends on the nature of the service. For example, payment systems generally require greater security than information services, such as a news magazine. Users of electronic payment systems demand that their account information and access to their accounts are beyond the reach of unauthorized persons. However, providers of and subscribers to information services may be less concerned with unauthorized access in view of the limited damages that may arise therefrom. As a result, companies offering services that require a greater degree of security, for example banking or payment services, generally trade ease-of-use, convenience, and availability and the cost of access device for security.

With required levels of security unlikely to change, the continued development of new devices and channels through which to access computer services have created new challenges for service providers. That is, service providers desire to make their services available to as wide an audience as possible through easy-to-use and portable devices, which may have less than ideal security features.

A system and method that address the aforementioned problems, as well as other related problems, are therefore desirable.

### SUMMARY OF THE INVENTION

In various embodiments, the invention provides tailorable access privileges for services based on session access characteristics. In a session between a user and a software application that provides one or more services, there are various access characteristics that describe the security of the session, for example, user authentication and encryption. Various combinations of access characteristics are defined and security levels are associated with the combinations. Each of the available services also has an associated security level. Access characteristics of a session are established after a user logs in to establish a session and the user is authenticated. When a service request is received, the session's access characteristics are used to determine the session's security level. If the session's security level satisfies the security level required by the requested service, access to the service is granted. Otherwise, access is denied. Since the access characteristics are determined when a session is established, and the security levels are tailorable, services can be provided via different channels and devices without compromising security.

It will be appreciated that various other embodiments are set forth in the Detailed Description and Claims which follow.

### BRIEF DESCRIPTION OF THE DRAWINGS

Various aspects and advantages of the invention will become apparent upon review of the following detailed description and upon reference to the drawings in which:

FIG. 1 is a functional block diagram of an e-commerce arrangement in accordance with one embodiment of the invention;

FIG. 2 is a flowchart of a process for managing and enforcing privilege levels in accordance with one embodiment of the invention;

FIG. 3 is a table of an example mapping of combinations of access characteristics to security levels; and

FIGS. 4A, 4B, 4C, and 4D are tables of example services and configurable security levels in accordance with another embodiment of the invention.

### DETAILED DESCRIPTION

Various embodiments of the present invention are described in terms of payment systems. Those skilled in the art will appreciate, however, that the invention could be implemented in combination with other types of computer services.

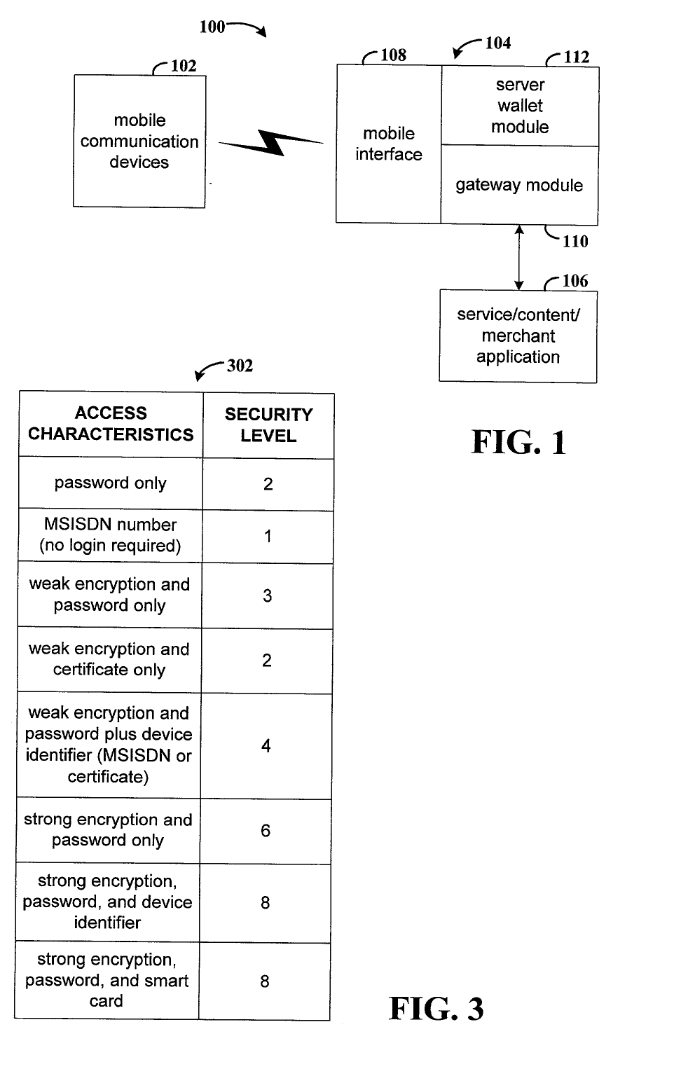

FIG. 1 is a functional block diagram of an e-commerce arrangement in accordance with one embodiment of the invention. Arrangement 100 includes communication devices 102, gateway arrangement 104, and a service application 106. Communication devices 102 include, for example, PCs, wireless telephones having display screens, and PDAs with telecommunication capabilities.

Service application 106 is application software, which is hosted by a suitable data processing system, through which goods, services, or information are offered over an electronic communications channel, for example, the Internet. The specific function of service application 106 may range from sales transactions to providing information. While not shown, it will be appreciated that web server software is used in conjunction with service application 106 to coordinate interactions with customers at web browsers.

In one embodiment, gateway arrangement 104 manages access privileges to the services provided by service application 106 and maintains session state between communication devices 102 and service application 106. Gateway arrangement 104 includes interface 108, a gateway module 110, and a server wallet module 112. Interface 108 and modules 110 and 112 can be implemented on one or more data processing systems in accordance with implementation requirements. Interface 108 represents a collection of channel-specific interfaces that are compatible with the different types of communications devices 102. Also included within interface 108 is software that provides a gateway between the channel-specific interfaces and modules 110 and 112.

A session is used to identify a set of interactions between a communication device 102 and the service application 106. It is necessary to correlate interactions between customers and the service application 106 with particular communication devices 102 so that the transactions are consistent with the customers'requests. In one embodiment, a session begins when a device 102 establishes a connection with interface 108 and ends when the connection is closed.

A customer connects with service application 106 through the user-interface provided by a communication device 102 and gateway arrangement 104. The interface 108 establishes the initial connection with the communication device 102 and assigns a wireless session identifier (WSID). The WSID is provided to the gateway module 110, and while the connection is maintained, subsequent input requests from the device 102 are associated with the WSID. The gateway module 110 passes the WSID to the service application 106, which assigns a corresponding merchant session identifier (MSID) and returns the MSID to the gateway module. The gateway module 110 maintains a table (not shown) that maps the WSIDs to the corresponding MSIDs. After a connection is established between the device 102 and the service application 106 and the WSID is mapped to an MSID, the gateway module 110 includes the MSID in subsequent requests from the communications device to the service application.

Depending on the particular service provided by application 106, some time during the session user authentication is required. For example, in a shopping application the authentication is required before a purchase and payment authorization are completed. For another application, user authentication is required before the user is provided access to the requested service. When gateway module 112 determines that user authentication is required, the WSID and control are transferred to the server wallet module 112. The server wallet module 112 authenticates the user using a method suitable for the communication device 102. For example, in one embodiment, the authentication is performed by soliciting and authenticating a user identifier and password entered at the communications device 102. In other embodiments, the authentication is via biometric information or smart card information obtained at the communication device. It will be appreciated that interface 108 provides the server wallet module 112 with information that identifies the type of communication device at which authentication is required. The server wallet module creates respective wallet session identifiers (WLSIDs) for sessions in which users have been authenticated.

Once a user has been authenticated, gateway module 110 uses the manner in which the user was authenticated, for example, smart card or user identifier and password, in combination with other access characteristics and administrator configured security levels to determine whether to permit access to the requested service. Access characteristics refer to the user authentication method and to additional communication characteristics of the session. For example, the access characteristics include the type of device (wireless communication or PC), ownership of the device (user's, public, unknown), and communication channel features (encryption, HTTP, SSL, WAP, SMS, communication provider). Different combinations of access characteristics are associated with various security levels, and the services that are provided by application 106 are associated with the security levels. The gateway module thereby determines whether to provide access to the requested service based on the security level associated with the requested service and the access characteristics of the session. In one embodiment, an administrator configures the combinations of access characteristics and associated security levels, along with the services and associated security levels. As new services are provided, new communication devices 102 are introduced, and new security mechanisms are employed, the administrator has the capability to define new combinations of access characteristics, security levels, and services.

In another embodiment, the application 106 is responsible for determining whether access to the requested service will be provided. The gateway module 110 determines the security level of the session and passes the security level to the application. The application is configured to determine which security levels are acceptable for which services.

In yet another example embodiment, the gateway module 110 and server wallet module 112 are implemented as separate services. The gateway module determines the security characteristics of each session, and the server wallet module decides whether the requested service can be provided based on the security characteristics of the session. Thus, the gateway module coordinates the association of access characteristics, security levels, and services.

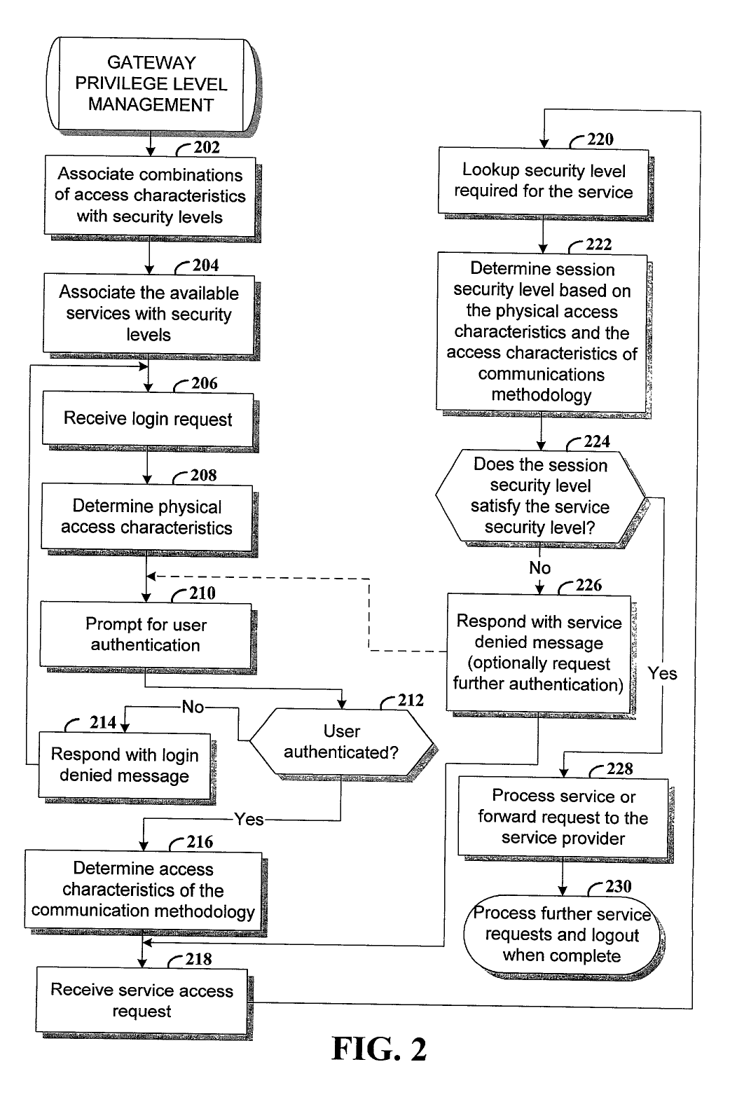

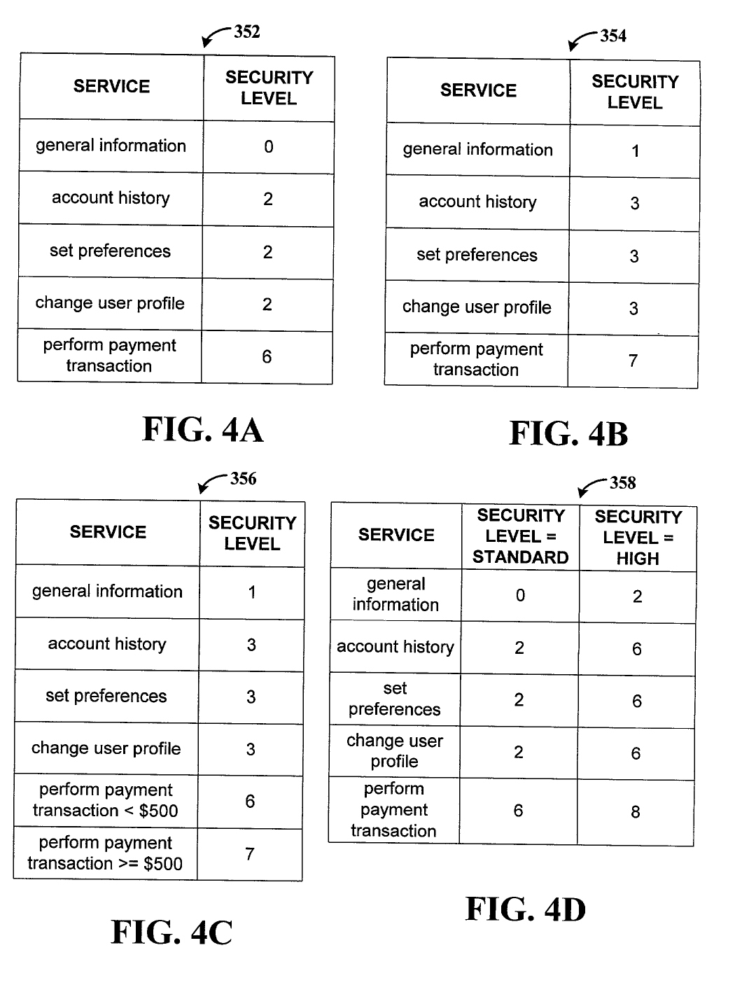

FIG. 2 is a flowchart of a process for managing and enforcing privilege levels in accordance with one embodiment of the invention. The process is performed at gateway arrangement 104 and generally entails configuring the various combinations of access characteristics, security levels, and available services, and enforcing access to the services with each service request. Those skilled in the art will appreciate that the embodiments of the flowchart are illustrative and that various other control flows would be suitable to implement the present invention. FIGS. 3 and 4A-D provide examples that are referenced in the following description of FIG. 2.

At step 202, various combinations of access characteristics are associated with security levels. For example, FIG. 3 is a table 302 of an example mapping of combinations of access characteristics to security levels. Table 302 lists only a few of the possible access characteristics and only a few of the possible combinations that could be used to define access privileges. The example characteristics of table 302 include password, MSIDN number, weak/strong encryption, device identifier, and smart card. MSISDN (Mobile Subscriber Integrated Services Digital Network) number is a subscriber number provided by a wireless telephone. Weak encryption implies, for example, a lesser number and strong encryption implies a greater number of bits used to encrypt information transmitted between the service application 106 and the communication device 102.

In the illustrated example, a greater number implies more restrictive security. For example, where the only user authentication is by password and no other access characteristics are identifiable, a security level 2 is assigned, and when the access characteristics include a password plus weak encryption, the security level is 3. When the access characteristics of a session satisfy a combination of access characteristics as found in table 302, the session is determined to have the associated security level. If the session's access characteristics satisfy more than one of the combinations, then the session is determined to have the greatest of the associated security levels. In another embodiment, each combination of access characteristics is in the form of a Boolean expression.

At step 204, each of the available services is associated with one of the possible security levels. FIGS. 4A, 4B, 4C, and 4D are tables of example services and configurable security levels in accordance with another embodiment of the invention. The left column lists the available services, and the right column lists the associated security levels. For access to be granted to a requested service, the session must have a combination of access characteristics that has an associated security level that is greater than or equal to the security level specified for the requested service. For example, if a session has strong encryption and password characteristics, the security level is 6 (FIG. 3). Thus, any of the services listed in table 352 (FIG. 4A) can be performed during the session. Another company may factor customer profile characteristics (e.g., smart card or device identifier) into the privilege determination and increase by 1 the security levels that are associated with the services as shown in table 354 of FIG. 4B.

At step 206, the process receives a login request from a user at a communication device. It will be appreciated that the particular sequence by which the login request is received is application dependent as previously described. At step 208, the process determines the physical access characteristics of the session. The physical access characteristics include, for example, the type of communication device 102 (wireless phone, PC, or PDA) ownership of the device (kiosk, or user-owned), and authentication method (password, smart card, or biometric). The device type and device characteristics are typically provided by a combination of the communication service provider and the device itself. For example, the communication service provider sends data that indicate the device type and some of the capabilities/characteristics of the device such as the number of lines available for display of information. In one embodiment, the communications service provider and the device itself provide data that describe ownership of the communications device. Thus, the service provider must ensure that the ownership characteristics communicated by the device are valid.

To determine the authentication method, the gateway arrangement 104 requests a starting level authentication based on the information received before the login. Examples of the data received from the device and service provider before the login include the subscriber number and encryption level (strong or weak). The gateway arrangement also tracks the actions the user has performed already in that session, for example, shopping cart information. Thus, selection of the the starting level authentication is based on the information already received from the device and service provider along with the actions the user has performed in that session. Alternatively, the user is prompted to choose the method of authentication.

Gateway arrangement 104 prompts the user for authentication at step 210. The manner of authentication depends on the capabilities of the communication device 102. For example, some devices have smart card readers, others have biometric readers, while others simply have a keypad. Decision step 212 tests whether the data returned from the communication device match that expected from a user of the device. It will be appreciated that gateway arrangement includes a database (not shown) of users and associated authentication data for verifying the authenticity of a user. If the authentication fails, the process continues at step 214 where the gateway arrangement 104 responds to the communication device 102 that the login was denied. Otherwise, the process continues at step 216.

At step 216, the process determines the access characteristics of the communications methodology established between the gateway arrangement 104 and the communications device 102. Different communications methodologies includes features such as HTTP, encryption type, SSL, WAP, and SMS. At step 218, the process receives a service access request from a communications device 102. Assuming that the user has already been successfully authenticated, the process is directed to step 220 where the security level associated with the requested service is obtained. For example, tables 352, 354, 356, and 358 illustrate different options for services and associated security levels.

At step 222, the session security level is obtained using the physical access characteristics along with the access characteristics of the communications methodology. Table 302 of FIG. 3 illustrates an example of different combinations of access characteristics and associated security levels. It will be appreciated that the combinations of access characteristics can be expressed using Boolean operators, thereby providing system flexibility. If the session access characteristics satisfy the expression of a combination of access characteristics, the associated security level is identified as the session security level. If the session access characteristics satisfy multiple expressions, then the session security level is the greatest of the associated security levels.

Decision step 224 tests whether the session security level satisfies the service security level. For example, in one embodiment if the value that represents the session security level is greater than or equal to the value that represents the service security level, access is permitted. If access is denied, the process is directed to step 226, where the user is informed that access to the service has been denied. The process then proceeds to step 218 to await another service request. In another embodiment, if access is denied the process is directed to step 210 to prompt for further user authentication. Generally, a user is not fully authenticated at the beginning of a session since the highest security level that will be required is unknown and the specific capabilities of the communications device are not entirely known by the gateway arrangement.

Decision step 224 directs the process to step 228 if the session security level satisfies the service security level. At step 228, depending on the application and implementation, the requested service is provided or the request is forwarded to a service provider for further processing. At step 230, further service requests are processed as described above, and the session is terminated either through inactivity or when the user indicates the session is complete.

FIGS. 4C and 4D are tables 356 and 358 that illustrate further example services and configurable security levels in accordance with another embodiment of the invention. FIG. 4C includes the services identified in tables 352 and 354 and in addition quantifies the service of “perform payment transaction.” For payment transactions in amounts less than $500, the required security level is 6, and for transactions >=$500 the required security level is 7. Thus, not only is the type of service request considered, but the parameters within the service request are also considered in determining the service security level.

FIG. 4D is a table that illustrates categories of security levels. The example categories are “standard” security and “high” security, and each category has an associated set of security levels. By providing security categories, an administrator can select an operating security category to easily switch between different sets of service security levels without having to individually reconfigure each security level. It will be appreciated that step 224 of FIG. 2 uses the security levels of the operating security category to determine whether access to the requested service is permitted.

The present invention is believed to be applicable to a variety of communication devices and types of computer service applications. The invention has been found to be particularly applicable and beneficial with wireless devices and financial transaction applications. Other aspects and embodiments of the present invention will be apparent to those skilled in the art from consideration of the specification and practice of the invention disclosed herein. It is intended that the specification and illustrated embodiments be considered as examples only, with a true scope and spirit of the invention being indicated by the following claims.

What is claimed is:

1. A computer-implemented method for managing access to computer-provided services for a plurality of requesters, comprising:
defining combinations of access characteristics and associating each of the combinations with a security level;
associating each of the services with one of the security levels;
processing a login request from a requester, whereby a session is initiated;
determining access characteristics of the session;
receiving a request for one of the services from the requester; and
granting access to the one of the services if the access characteristics of the session are associated with a security level that satisfies the security level associated with the one of the services.

2. The method of claim 1, further comprising, if the access characteristics of the session are associated with a security level that does not satisfy the security level requirement associated with the one of the services, then prompting the requester for authentication data.

3. The method of claim 1, wherein the access characteristics include a type of device with which the session is maintained.

4. The method of claim 1, wherein the access characteristics include ownership rights of a device with which the session is maintained.

5. The method of claim 1, wherein the access characteristics include characteristics of a network over which the session is maintained.

6. The method of claim 1, further comprising authenticating the requester with a selected authentication method, wherein the access characteristics include characteristics of the authentication method.

7. The method of claim 1, further comprising associating each of the services with one of the security levels in response to user selections of the security levels.

8. The method of claim 1, further comprising:
providing a plurality of user-selectable security categories, each security category including a set of security levels associated with the services;
establishing one of the security categories as an operating security category in response to user selection of the one of the security categories; and
granting access to the one of the services if the access characteristics of the session are associated with a security level that satisfies the security level requirement associated with the one of the services in the operating security category.

9. In a system including a plurality of communications devices coupled to one or more computer-provided services via a gateway arrangement, a method for managing access to the services for a plurality of users at the communications devices, comprising:
defining combinations of access characteristics and associating each of the combinations with a security level at the gateway arrangement;
associating each of the services with one of the security levels at the gateway arrangement;
processing a login request from a user at the gateway arrangement, whereby a session is initiated between a communications device and a service;
determining access characteristics of the session at the gateway arrangement;
receiving at the gateway arrangement a request for one of the services from the user of the communications device; and
granting access to the one of the services if the access characteristics of the session are associated with a security level that satisfies the security level associated with the one of the services.

10. The method of claim 9, further comprising, if the access characteristics of the session are associated with a security level that does not satisfy the security level requirement associated with the one of the services, then prompting the user at the communication device for authentication data.

11. The method of claim 9, wherein the access characteristics include a type of device with which the session is maintained.

12. The method of claim 9, wherein the access characteristics include ownership rights of a device with which the session is maintained.

13. The method of claim 9, wherein the communications device is coupled to the gateway arrangement via a network, and the access characteristics include characteristics of the network over which the session is maintained.

14. The method of claim 9, further comprising authenticating the user with a selected authentication method, wherein the access characteristics include characteristics of the authentication method.

15. The method of claim 9, further comprising associating each of the services with one of the security levels in response to user selections of the security levels.

16. The method of claim 9, further comprising:
providing a plurality of administrator-selectable security categories at the gateway arrangement, each security category including a set of security levels associated with the services;
establishing one of the security categories as an operating security category at the gateway arrangement in response to administrator selection of the one of the security categories; and
granting access to the one of the services if the access characteristics of the session are associated with a security level that satisfies the security level requirement associated with the one of the services in the operating security category.

17. An apparatus for managing access to computer-provided services for a plurality of users operating respective communications devices, comprising:
means for defining combinations of access characteristics and associating each of the combinations with a security level;
means for associating each of the services with one of the security levels;
means for processing a login request from a user, whereby a session is initiated;
means for determining access characteristics of the session;
means for receiving a request for one of the services from the user; and
granting access to the one of the services if the access characteristics of the session are associated with a security level that satisfies the security level associated with the one of the services.

18. A gateway arrangement for managing access to computer-provided services for a plurality of users at respective communications devices, comprising a computing system configured with combinations of access characteristics and associated security levels and services associated with the security levels, the gateway arrangement further configured to process login requests from the users and establish sessions between the communications devices and the services, determine access characteristics of the sessions, and selectively grant access to a service requested by a user if the access characteristics of the user's session are associated with a security level that satisfies the security level associated with the service.

19. The apparatus of claim 18, wherein the access characteristics are selected from the group including a type of device with which the sessions are maintained, ownership rights of devices with which the sessions are maintained, and characteristics of a network over which the sessions are maintained.

20. The apparatus of claim 19, wherein the computing system is further configured to authenticate the users with one or more selected authentication methods, wherein the access characteristics include characteristics of the authentication methods.
